(19) United States
(12) Patent Application Publication
(10) Pub. No.: US 2013/0176584 A1
(43) Pub. Date: Jul. 11, 2013

(54) NETWORK SYSTEM, CLIENT APPARATUS, METHOD THEREFOR, AND PROGRAM

(71) Applicant: Keiichi Takashima, Kawasaki-shi (JP)

(72) Inventor: Keiichi Takashima, Kawasaki-shi (JP)

(73) Assignee: CANON KABUSHIKI KAISHA, Tokyo (JP)

(21) Appl. No.: 13/698,583

(22) PCT Filed: Sep. 11, 2012
(86) PCT No.: PCT/JP2012/073770

§ 371 Date: Nov. 16, 2012

(30) Foreign Application Priority Data
Oct. 14, 2011 (JP) 2011-227438
Jul. 12, 2012 (JP) 2012-156926

(51) Int. Cl. G06F 3/12

(52) U.S. Cl. CPC G06F 3/1297
USPC 358/1.13

(57) ABSTRACT

A network system in which a server apparatus is connected to a client apparatus via a network, characterized in that the server apparatus includes transmission means for transmitting identification information used to install a model-specific printer driver corresponding to a printer having undergone shared setting in accordance with a request from the client apparatus, and the client apparatus includes request means for issuing a request for the identification information to the server apparatus to update a basic driver which corresponds to a printer having undergone shared setting in the server apparatus and has been installed by using Point and Print, and control means for controlling installation of the model-specific printer driver by using the identification information transmitted in accordance with the request.

### TECHNICAL FIELD

The present invention relates to a network system, a client apparatus, a method therefor, and a program and, more particularly, to a technique of installing a printer driver.

### BACKGROUND ART

Recently, as computers and various kinds of devices have been networked in offices, a plurality of client computers share one printer. In a network system constructed by Windows® available from Microsoft, a printer driver installation method called Point & Print (Point and Print) is generally used. Owing to the mechanism of Point and Print, general users can easily use a shared printer without preparing any printer driver installation medium or checking the IP address of the printer in advance.

Many intra-company systems strictly manage to allow only specific printer drivers to be installed in client computers in order to reduce the management costs for the systems. For this reason, using the mechanism of Point and Print allows a system manager to easily manage printer drivers in client computers.

The Point and Print mechanism still has some complexities. For example, it is difficult for the Point and Print mechanism to distribute modules outside the installation set of a printer driver—for example, an Add-in module which expands the function of the printer driver—to client computers.

As a method of solving the above problem, the following technique has been disclosed (for example, Japanese Patent Laid-Open No. 2005-338940). That is, the installation set of a driver to be registered in a print server is packaged with a status monitor designated in advance, an uninstaller, and data instructing an installation method. This makes the printer driver install the status monitor and the uninstaller after being installed in a client computer by Point and Print.

In this case, after registering an installation set in the print server, the system manager may wish to install other applications together with the printer driver. In such a case, however, the conventional method described above makes it necessary to remake the printer driver's installation set and re-register it in the print server.

In addition, when the manager wants to change the printer to be shared to a different type of printer, for example, he/she needs to re-install a corresponding printer driver in the print server.

Furthermore, when the manager has registered the above installation set in the print server, the user of a client computer needs to re-install the printer driver via Point and Print, thus requiring tiresome operations.

As described above, the conventional mechanism of Point and Print described above requires tiresome operations when the contents to be installed by Point and Print have changed.

### SUMMARY OF INVENTION

Under the circumstances, the present invention provides a technique capable of updating the printer driver installed in a client computer to an appropriate printer driver corresponding to a shared printer at the time of installation while using the conventional mechanism of Point and Print, so as to make operation for the manager more convenient as compared to conventional operation.

According to one aspect of the present invention, there is provided a network system in which a server apparatus is connected to a client apparatus via a network, characterized in that the server apparatus includes transmission means for transmitting identification information used to install a model-specific printer driver corresponding to a printer having undergone shared setting in accordance with a request from the client apparatus, and the client apparatus includes request means for issuing a request for the identification information to the server apparatus to update a basic driver which corresponds to a printer having undergone shared setting in the server apparatus and has been installed by using Point and Print, and control means for controlling installation of the model-specific printer driver by using the identification information transmitted in accordance with the request.

According to another aspect of the present invention, there is provided a method in a network system in which a server apparatus is connected to a client apparatus via a network, characterized in that the server apparatus includes a transmission step of transmitting identification information used to install a model-specific printer driver corresponding to a printer having undergone shared setting in accordance with a request from the client apparatus, and the client apparatus includes a request step of issuing a request for the identification information to the server apparatus to update a basic driver which corresponds to a printer having undergone shared setting in the server apparatus and has been installed by using Point and Print, and a control step of controlling installation of the model-specific printer driver by using the identification information transmitted in accordance with the request.

According to still another aspect of the present invention, there is provided a client apparatus connected to a server apparatus via a network, characterized by comprising: request means for issuing a request for identification information used to install a model-specific printer driver corresponding to a printer which has undergone shared setting in the server apparatus and is installed by using Point and Print to update a basic driver corresponding to the printer having undergone shared setting; and control means for performing control to install the model-specific printer driver by using identification information transmitted in accordance with the request.

According to yet another aspect of the present invention, there is provided a method in a client apparatus connected to a server apparatus via a network, characterized by comprising: a request step of issuing a request for identification information used to install a model-specific printer driver corresponding to a printer which has undergone shared setting in the server apparatus and is installed by using Point and Print to update a basic driver corresponding to the printer having shared setting; and a control step of performing control to install the model-specific printer driver by using identification information transmitted in accordance with the request.

The present invention can provide a technique capable of updating the printer driver installed in a client computer to an appropriate printer driver corresponding to a shared printer at the time of installation while using the conventional mechanism of Point and Print so as to make operation for the manager more convenient as compared to conventional operation.

Further features of the present invention will become apparent from the following description of exemplary embodiments (with reference to the attached drawings).

### BRIEF DESCRIPTION OF DRAWINGS

FIG. 1 is a block diagram showing the arrangement of a network system;

FIG. 2 is a block diagram showing an example of the arrangement of a computer functioning as a client apparatus or a server apparatus;

FIG. 3 is a block diagram showing the module arrangement of the network system;

FIG. 4 is a sequence chart showing an installation method of installing a printer driver;

FIG. 5 is a view showing an example of the data structure of a printer object attributes 500;

FIG. 6 is a flowchart showing detailed processing at the second stage (steps S403 to S409);

FIG. 7 is a flowchart showing detailed processing at the third stage (steps S410 to S419);

FIG. 8 is a flowchart showing the details of driver update processing;

FIG. 9 is a view showing an example of the data structure of shared printer information 900;

FIG. 10 is a view showing an example of a model-specific printer driver update confirmation window;

FIG. 11 is a block diagram showing another example of the module arrangement of a network system;

FIG. 12 is a view showing an example of a printer driver updating/setting window;

FIG. 13 is a view showing an example of the data structure of printer driver update settings 1300;

FIG. 14 is a flowchart showing the details of initialization processing of a basic printer driver 313;

FIG. 15 is a view showing an example of determining an update timing based on a startup count; and

FIG. 16 is a view showing an example of a model driver updating/printing confirmation window.

### DESCRIPTION OF EMBODIMENTS

An embodiment of the present invention will be described below with reference to the accompanying drawings. This embodiment will exemplify the processing of installing a printer driver in a client apparatus in a network system in which the client apparatus, a print server, and a printer are connected via a network.

### First Embodiment

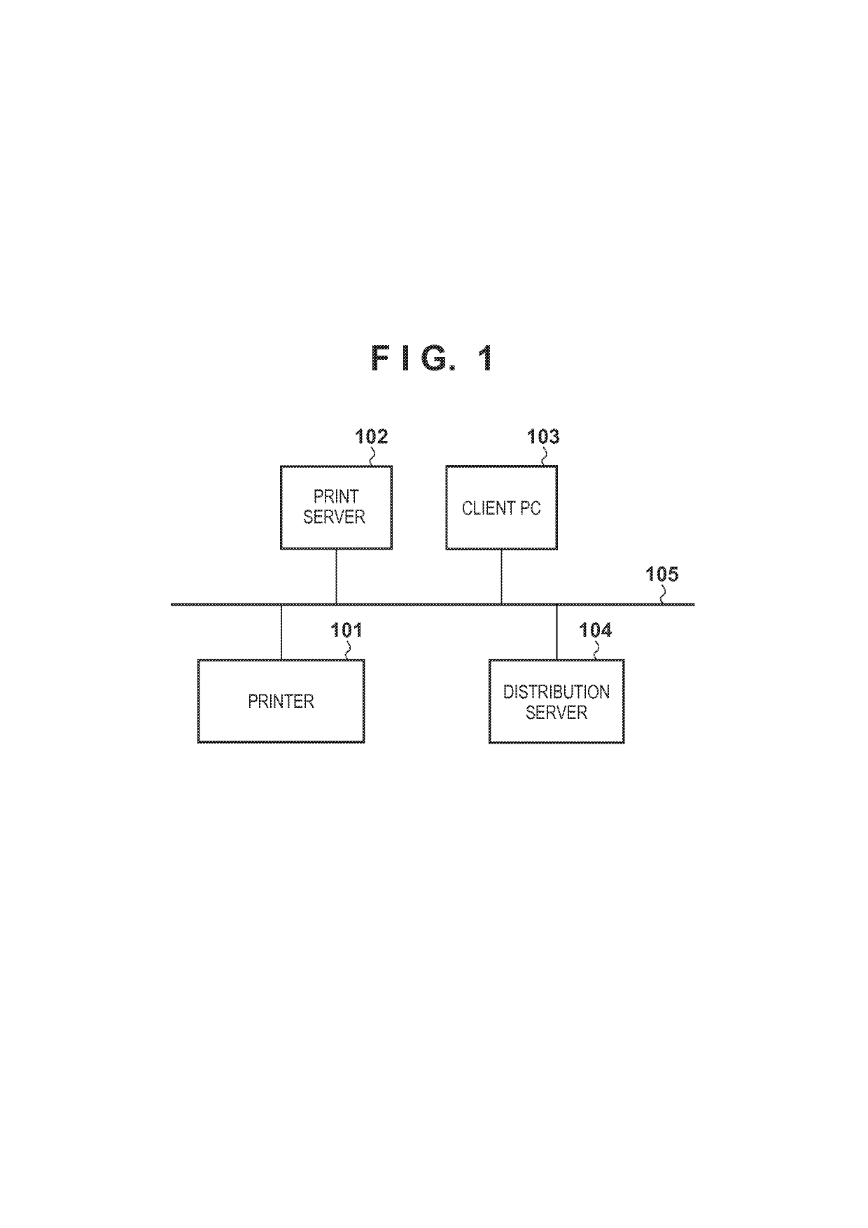

The arrangement of a network system in the first embodiment to which the present invention can be applied will be described with reference to the block diagram shown in FIG. 1. In this case, a printing system of Windows® available from Microsoft will be exemplified as an operating system. Obviously, the present invention can be applied to any devices regardless of their arrangements as long as the function of the present invention can be implemented. In addition, this system may include a single device, a system constituted by a plurality of devices, and a system which is connected via a network such as a LAN (Local Area Network) or WAN (Wide Area Network) to perform processing.

The network system according to this embodiment includes a printer 101, a print server 102, a client apparatus (client PC) 103, and a distribution server 104. “PC” is an abbreviation for a personal computer. The printer 101, the print server 102, the client PC 103, and the distribution server 104 are communicatively connected to each other via a network 105 such as a LAN or WAN.

The printer 101 has a function of printing a print job. This printer may be a single-function printer or the printing unit of a multifunctional peripheral device.

The print server 102 has a function of managing the print job issued by the client PC 103 and managing the printer 101 connected via the network 105 or a local port such as a USB (not shown). The print server 102 also manages the printer driver distributed to the client PC 103 by Point and Print.

The client PC 103 has a function of issuing a print instruction to the printer 101. When an application issues a print instruction, the client PC 103 transmits a print job to the printer 101 via the print server 102.

The distribution server 104 has a function of distributing a printer driver. Upon receiving a request to distribute a printer driver set from the print server 102 or the client PC 103, the distribution server 104 distributes the printer driver set via the network 105. WindowsUpdate managed by Microsoft is an example of the distribution server 104.

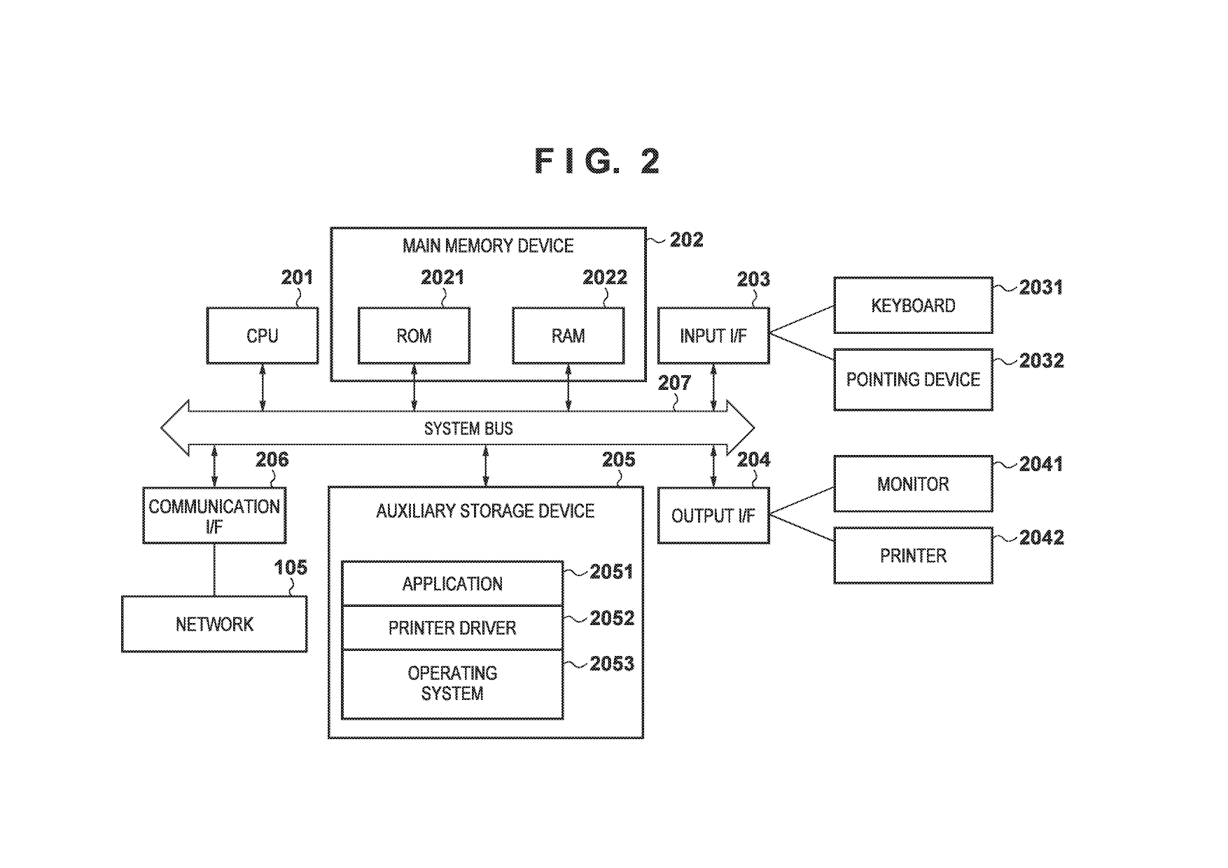

The arrangement of a computer functioning as a client apparatus (client PC 103) or a server apparatus (the print server 102 and the distribution server 104) will be described next with reference to the block diagram shown in FIG. 2. A CPU 201 controls the overall apparatus in accordance with the programs stored in a ROM 2021 or RAM 2022 of a main memory device 202 or an auxiliary storage device 205. The RAM 2022 is also used as a work area when the CPU 201 performs various kinds of processing. The auxiliary storage device 205 stores an operating system (OS) 2053, a printer driver 2052, application software 2051, and the like.

Input devices such as a keyboard 2031 and a pointing device 2032 typified by a mouse and a touch panel are devices with which the user gives various kinds of instructions to the computer via an input I/F 203. An output I/F 204 is an interface for outputting data to the outside, and outputs data to output devices such as a monitor 2041 and a printer 2042. The computer may be connected to the printer 2042 not only via a directly connected local I/O but also via the network 105 connected via a communication I/F 206. In addition, the respective modules exchange data via a common data system bus 207.

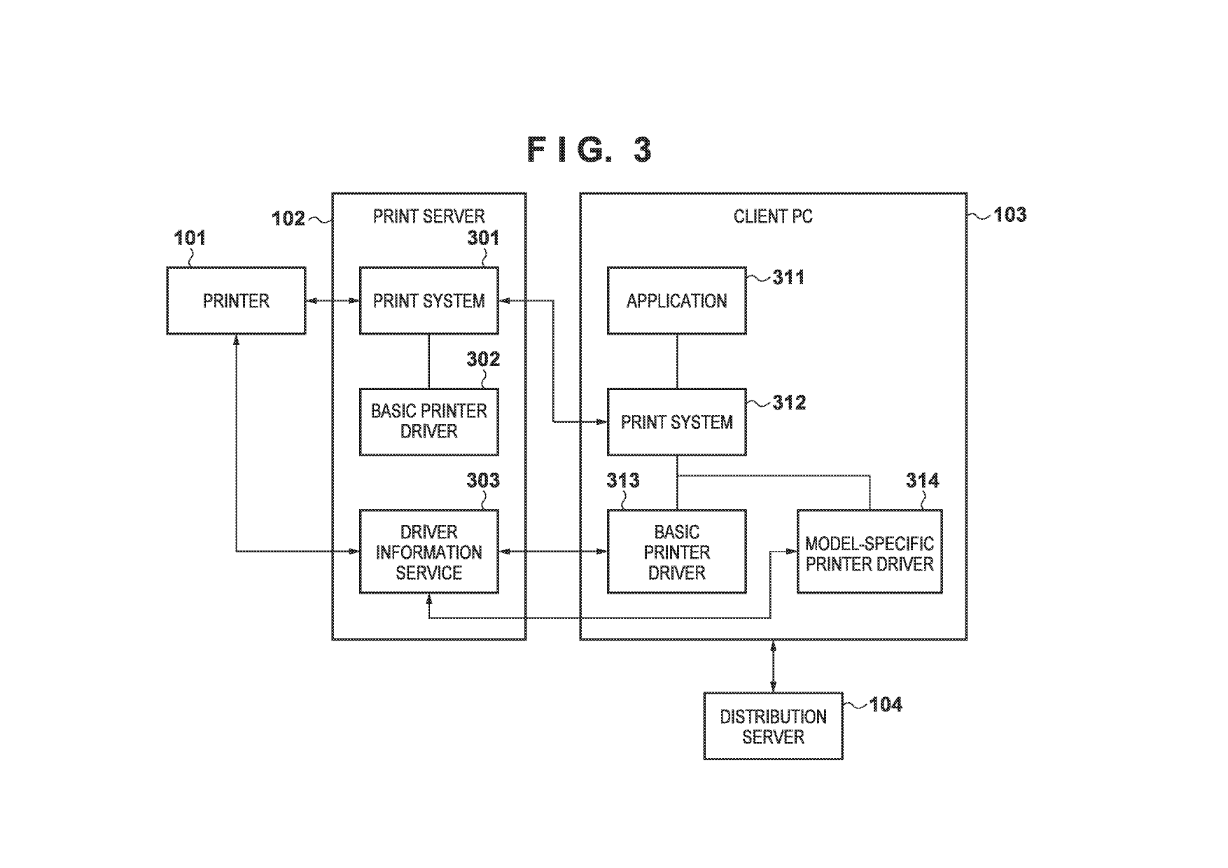

The module arrangement of the network system shown in FIG. 1 will be described below with reference to the block diagram shown in FIG. 3. The print server 102 includes a print system 301 including a spooler, a basic printer driver 302, and a driver information service 303.

The print system 301 is part of the OS. The print system 301 provides the connected printer 101 as a shared printer, receives a print job from the client PC 103, and outputs the job to the printer 101. In response to a request from the client PC 103, the print system 301 distributes the basic printer driver 302 associated with the shared printer.

Printer drivers include a basic printer driver and a model-specific printer driver.

The basic printer driver (also called a class driver) is a general-purpose printer driver which is not specific to any model, and generally allows many printers which support a specific PDL (Page Description Language) to print. For example, a printer driver generally called a generic printer driver is a kind of basic printer driver. Installing a basic printer driver eliminates the need to install a printer driver for each model. However, the basic printer driver incorporates no control method for an option device developed afterward. For this reason, this driver does not allow to use any model-specific function, and mainly incorporates basic functions which make no difference in control method for each model.

In addition, the basic printer driver is sometimes managed as an in-box driver by the OS operating on the computer. Portable terminals such as tablet PCs different from general desktop PCs and notebook PCs are sometimes designed on the premise that they use only basic drivers as in-box drivers.

In contrast, a model-specific printer driver is a printer driver which corresponds to a specific model and allows to use functions unique to the model. The driver information service 303 provides the model-specific printer driver information of the printer 101.

The client PC 103 includes an application 311, a print system 312, the basic printer driver 313, and a model-specific printer driver 314. The application 311 outputs print data to the print system 312 in response to a print instruction from the user. A printing system of Windows® uses a GDI (Graphics Device Interface) command or XPS (XML Pater Specification) data as print data. The print system 312 is part of the OS. The print system 312 outputs the print data received from the application 311 to the basic printer driver 313 and the model-specific printer driver 314.

The basic printer driver 313 and the model-specific printer driver 314 receive print data from the print system 312, and convert the data into a control command recognizable to the printer 101, for example, a command in the page description language (PDL). The print system 312 outputs the converted printer control command as print data to the printer 101 via the print system 301 of the print server 102.

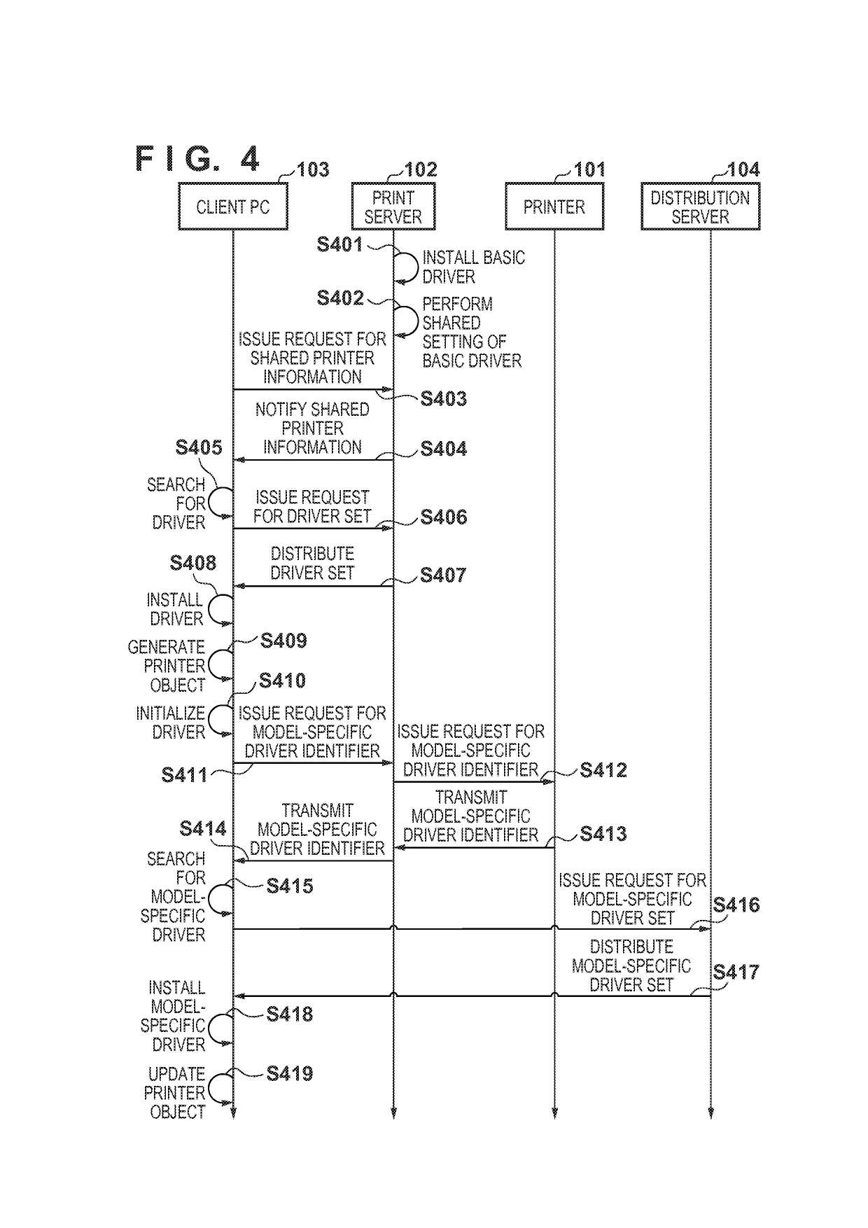

A method of installing a printer driver will be described next with reference to the sequence chart of FIG. 4.

The sequence shown in FIG. 4 is constituted by steps in the following three stages. At the first stage, the basic printer driver 302 is installed in the print server 102 and shared settings are made (steps S401 and S402). At the second stage, the mechanism of Point and Print distributes the basic printer driver 302 from the print server 102 to the client PC 103 to install the driver (steps S403 to S409). At the third stage, the client PC 103 issues an instruction to the print system 312 to update the installed basic printer driver 313 to the model-specific printer driver 314 at the time of initialization processing (steps S410 to S419).

Processing at the first stage (steps S401 and S402) will be described first. The system manager installs the basic printer driver 302 which supports the printer 101 in the print server 102 (step S401). At the time of installation, the manager designates the port to which the printer 101 is connected. For example, the manager sets a port such as “USB001” in the case of USB connection, and sets a TCP/IP port with the IP address of the printer 101 in the case of TCP/IP connection. The print system 301 then generates a printer object corresponding to the printer 101, and displays the object on the control panel, and sets printer object attributes 500 for each printer object.

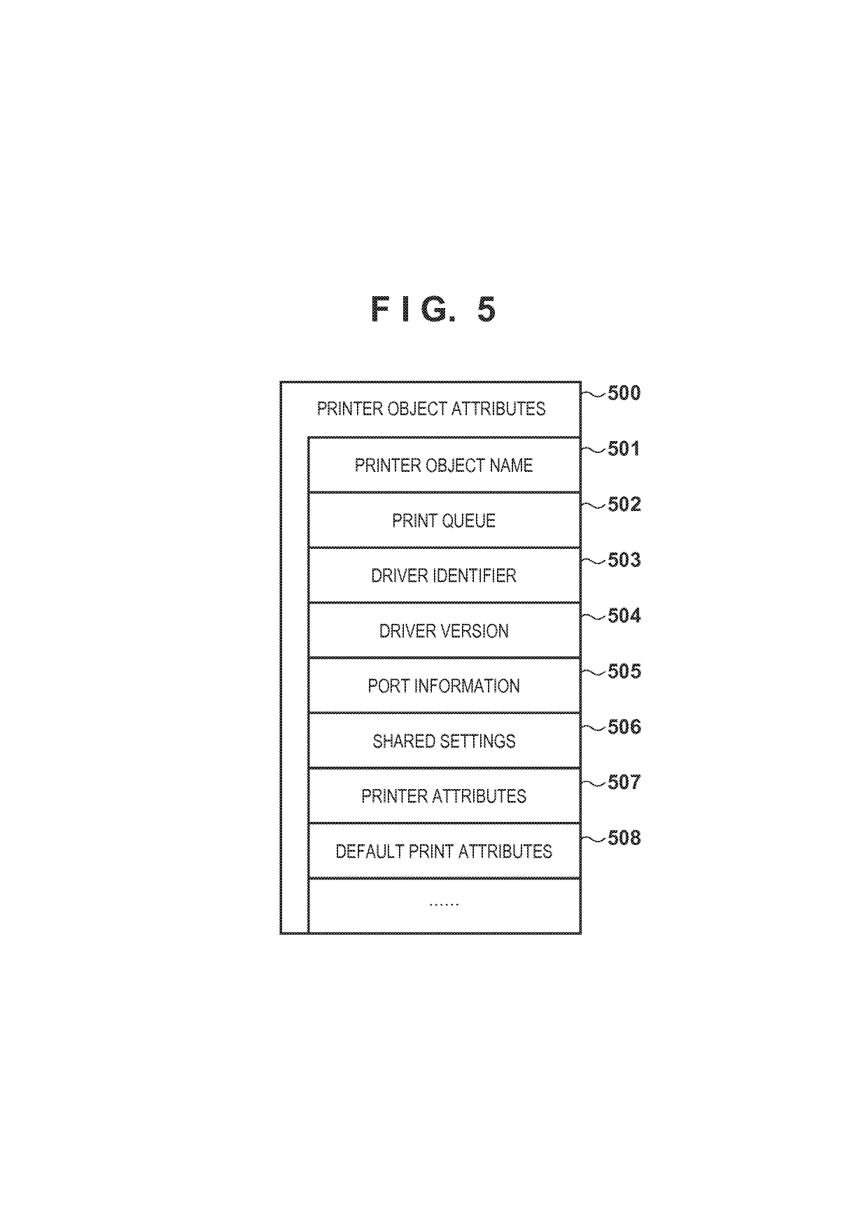

FIG. 5 shows an example of the data structure of the printer object attributes 500. The printer object attributes 500 includes a printer object name 501, a print queue 502, a driver identifier 503, a driver version 504, and port information 505. In addition, the printer object attributes 500 include shared settings 506, printer attributes 507, and default print attributes 508.

The printer object name 501 is a name by which the user identifies a printer object. Immediately after installation, the model name of the printer driver is set. However, the user can arbitrarily change it. The print queue 502 is the file name of a print queue storing a spooled print job. When generating a printer object, the print system 301 uniquely generates a print queue file in the auxiliary storage device 205 so as to inhibit the file from being changed. The driver identifier 503 and the driver version 504 are respectively identification information and a version number which allow to uniquely specify the printer driver associated with a printer object. At the time of installation of a new printer driver or updating, the print system 301 sets the identification information and version number of the installed printer driver.

The port information 505 is information including the type and port name of the port to which the printer 101 is connected. At the time of installation, the print system 301 sets information concerning a designated port. However, the user can change the information in accordance with the connection port of the printer. The shared settings 506 include settings concerning information indicating whether to share, a shared name, and an access authority with respect to a user group permitted to share. The printer attributes 507 and the default print attributes 508 are the attributes set by the printer driver associated with a printer object. The printer attributes 507 are set in accordance with the printer 101, for example, the option configuration of the printer 101. The default print attribute 508 are the initial values of print attributes used when an application prints.

When a printer object is generated, the system manager further sets the shared settings 506 for a printer object (step S402). The printer object for which shared settings have been made in the print server 102 can be displayed on the client PC 103.

Processing at the second stage (steps S403 to S409) in FIG. 4 will be described next. A general user displays, on the client PC 103, a shared printer in the print server 102. The user selects a printer object with the shared name set in step S402 and executes a connection command. As a result, the print system 312 of the client PC 103 requests the print server 102 for information concerning the selected shared printer (step S403).

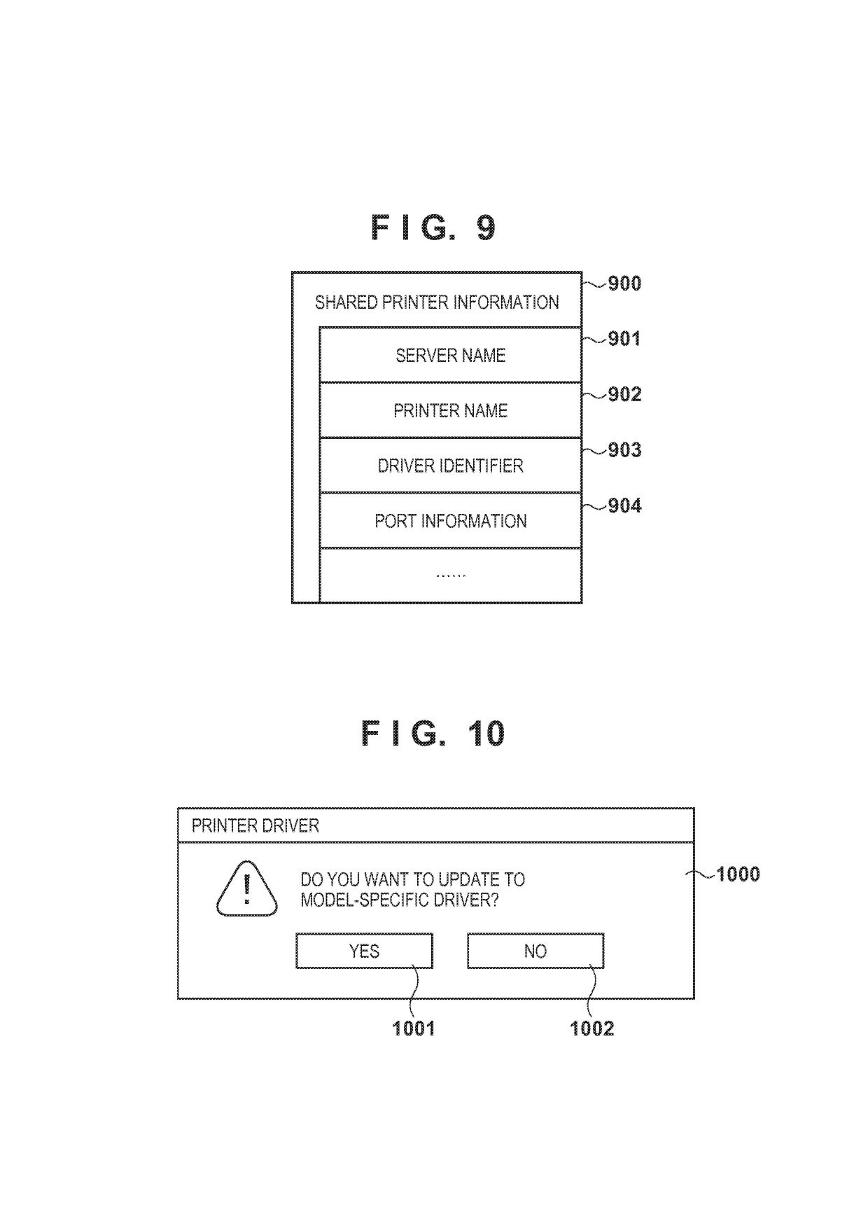

FIG. 9 shows an example of the data structure of information (shared printer information 900) concerning the shared printer. The shared printer information 900 includes a server name 901, a printer name 902, a driver identifier 903, and port information 904. The server name 901 is a name uniquely representing the print server 102 on the network 105. The printer name 902 is the shared name of the shared printer set in step S402. The driver identifier 903 is identification information which can uniquely specify the printer driver associated with the shared printer. The port information 904 is a port setting for the printer object on the print server 102.

Upon receiving a request, the print system 301 of the print server 102 notifies the client PC 103 of the designated shared printer information (step S404). This allows the print system 312 of the client PC 103 to acquire the shared printer information 900. The print system 312 then executes search processing concerning the printer driver indicated by the driver identifier 903 (that is, the basic printer driver 302) (step S405). The print system 312 of the client PC 103 requests the print server 102 for the driver set of the printer driver indicated by the driver identifier 903, as needed (step S406). Upon receiving the request, the print system 301 of the print server 102 distributes the driver set of the designated printer driver to the client PC 103 (step S407).

Note that in step S405, the client PC 103 may search for and select a basic printer driver corresponding to the shared printer information 900 received in step S404 from the in-box driver managed by the OS of the client PC 103. In this case, the request processing and distribution processing for the printer driver between the client PC 103 and the print server in steps S406 and S407 are omitted.

The print system 312 of the client PC 103 installs the driver set received from the print server 102 or the printer driver managed by the OS as an ink-box driver (step S408). In addition, the print system 312 generates a printer object corresponding to the shared printer (that is, the printer 101) selected by the print server 102, displays the object on the control panel, and sets attributes (step S409).

Processing at the third stage in FIG. 4 (steps S410 to S419) will be finally described below. After the installation of the basic printer driver 313, the print system 312 of the client PC 103 invokes initialization processing of the basic printer driver 313 (step S410).

In the initial processing of the basic printer driver 313, after conventional initialization processing, the client PC 103 requests the print server 102 for the identifier of the model-specific printer driver of the printer 101 connected to the port indicated by port information 505 (step S411). Upon receiving the request, the driver information service 303 of the print server 102 requests the printer 101 connected to the designated port for the identifier of the model-specific printer driver (step S412). Upon receiving the request, the printer 101 transmits the identifier of the model-specific printer driver of the printer 101 to the print server 102 (step S413).

Upon acquiring the identifier of the model-specific printer driver from the printer 101, the driver information service 303 of the print server 102 notifies the client PC 103 of the corresponding information (step S414). This makes the basic printer driver 313 of the client PC 103 acquire the identifier of the model-specific printer driver. The acquired identifier indicates the model-specific printer driver 314. The basic printer driver 313 of the client PC 103 instructs the print system 312 to update the printer driver associated with the printer object to the model-specific printer driver 314.

The print system 312 of the client PC 103 executes search processing concerning the printer driver indicated by the designated driver identifier (that is, the model-specific printer driver 314) (step S415). The print system 312 of the client PC 103 requests the distribution system (distribution server 104) for the driver set of the model-specific printer driver 314, as needed (step S416). The distribution system is a system which can executively manage printer drivers and associated software for each vendor or a plurality of vendors and distribute them to the client PC 103 via a network. Upon receiving the request, the distribution server 104 distributes the driver set of the model-specific printer driver 314 to the client PC 103 (step S417). The print system 312 of the client PC 103 installs the received driver set (step S418). The print system 312 of the client PC 103 updates the attributes of the printer object as an update target (step S419).

Note that in this embodiment, the client PC 103 acquires the identifier of the model-specific printer driver from the print server 102 in the processing in steps S411 to S414. However, at the timing of steps S403 and S404, the client PC 103 may acquire, from the print server 102, information corresponding to the identifier of the model-specific printer driver as part of the shared printer information 900 or its additional information. In this case, it is possible to omit the processing in steps S411 to S414 for the update processing in steps S418 and S419.

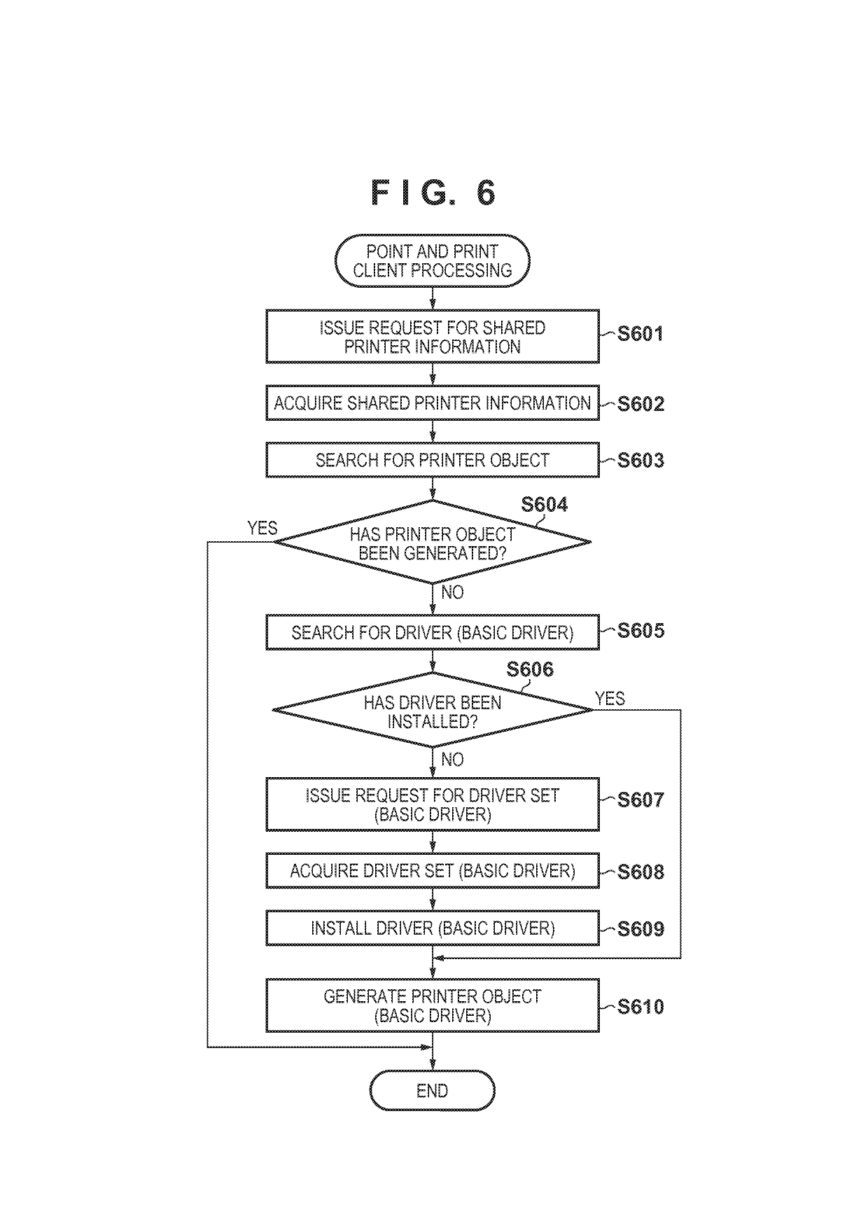

Detailed processing at the second stage (steps S403 to S409) in the sequence chart shown in FIG. 4 will be described next with reference to the flowchart shown in FIG. 6. This processing is the details of the processing in which the print system 312 installs the basic printer driver 313 in the client PC 103.

In step S601, the print system 312 requests the print server 102 for information concerning the selected shared printer in accordance with user operation from the client PC 103. In step S602, the print system 312 acquires the shared printer information 900 of the designated shared printer in response to the request from the print system 301 of the print server 102.

In step S603, the print system 312 performs a search to check, based on the acquired shared printer information 900, whether there has already been a printer object corresponding to the shared printer (the printer 101 in this case). Upon determining in step S604 that a printer object has already been generated (YES in step S604), the print system 312 terminates this processing.

If the print system 312 determines in step S604 that no printer object has been generated (NO in step S604), the process advances to step S605. The print system 312 then performs a search to check whether the basic printer driver 302 indicated by the driver identifier 903 of the acquired shared printer information 900 has already been installed. If the print system 312 determines in step S606 that the basic printer driver 302 has been installed (YES in step S606), the process advances to step S610. If the print system 312 determines that the basic printer driver 302 has not been installed (NO in step S606), the process advances to step S607, in which the print system 312 requests the print server 102 for the driver set of the printer driver indicated by the driver identifier 903. In step S608, the print system 312 acquires the driver set of the designated printer driver in response to a request from the print system 301 of the print server 102. In step S609, the print system 312 installs the received driver set.

Although the client PC 103 acquires a printer driver from the print server 102 in steps S607 and S608, the client PC 103 may implement this processing by acquiring a basic printer driver managed as an in-box driver by the OS of the client PC 103. In this case, in step S607, the print system 312 searches the in-box driver for a corresponding printer driver by using the shared printer information 900, and acquires the found printer driver in step S608. In step S609, the print system 312 installs the basic printer driver managed as an in-box driver.

In step S610, the print system 312 generates a printer object corresponding to the printer driver which has already been installed. More specifically, the print system 312 generates a printer object corresponding to the selected shared printer (the printer 101 in this case) of the print server 102 on the control panel. The installed basic printer driver 313 is then associated with the printer object. The print system 312 sets the printer name 902 of the shared printer information 900 to the name of the registered printer object. In addition, the print system 312 sets the port indicated by the port information 904 of the shared printer information 900 to the port setting of the registered printer object, and inhibits the user from changing the setting. With the above processing, the print system 312 terminates the installation processing.

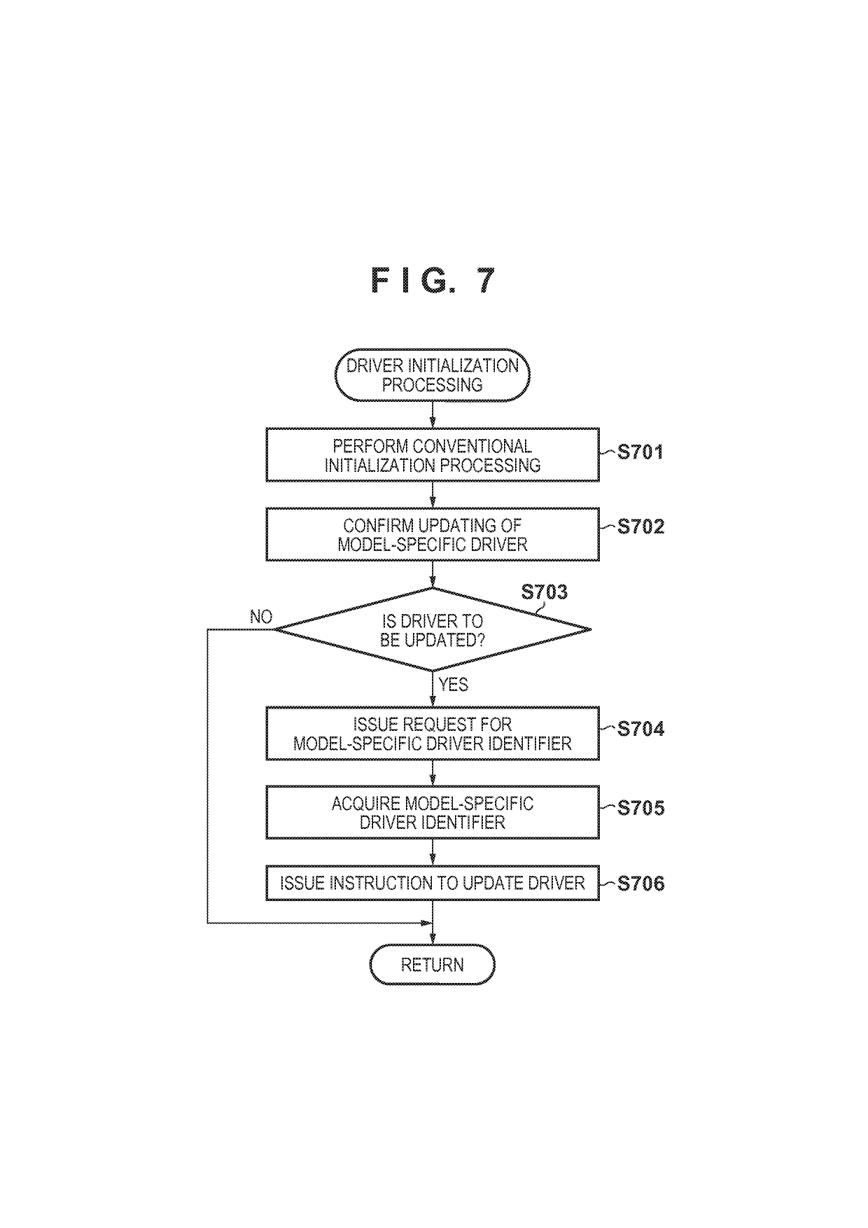

Detailed processing at the third stage (steps S410 to S419) in the sequence chart shown in FIG. 4 will be described next with reference to the flowchart shown in FIG. 7. This processing is the detailed initialization processing of the basic printer driver 313 in the client PC 103.

In step S701, the basic printer driver 313 performs conventional initialization processing. In step S702, the basic printer driver 313 displays a window for confirming whether the driver is to be updated to the model-specific printer driver 314, and accepts an input from the user. In a system which is sufficient with the function of the basic printer driver 302, choosing not to update the model-specific printer driver 314 provides the following effects. That is, it is possible to provide a uniform operational feeling regardless of the model of the printer 101. It is also possible to use the same printer driver without any change. Furthermore, in an intra-company system, it is not necessary to re-evaluate an application, which is often required when a printer driver is updated.

An example of a user interface window for confirming whether to update a model-specific printer driver will be described below with reference to FIG. 10. To update the basic printer driver 313 to the model-specific printer driver 314, the user presses a “YES” button 1001. To keep the basic printer driver 313 unchanged, the user presses a “NO” button 1002.

If the basic printer driver 313 determines in step S703 that the user has pressed the “NO” button 1002 on a model-specific printer driver update confirmation window 1000 (NO in step S703), the basic printer driver 313 closes the model-specific printer driver update confirmation window 1000 and terminates this processing.

If the basic printer driver 313 determines that the user has pressed the “YES” button 1001 (YES in step S703), the process advances to step S704. In step S704, the basic printer driver 313 requests the print server 102 for the identifier of the model-specific printer driver of the printer 101 connected to the port indicated by the port information 505. In step S705, the basic printer driver 313 acquires the identifier of the model-specific printer driver in response to the request from the driver information service 303 of the print server 102. The acquired printer driver identifier indicates the model-specific printer driver 314. In step S706, the basic printer driver 313 instructs the print system 312 to update the printer driver associated with the printer object to the model-specific printer driver 314.

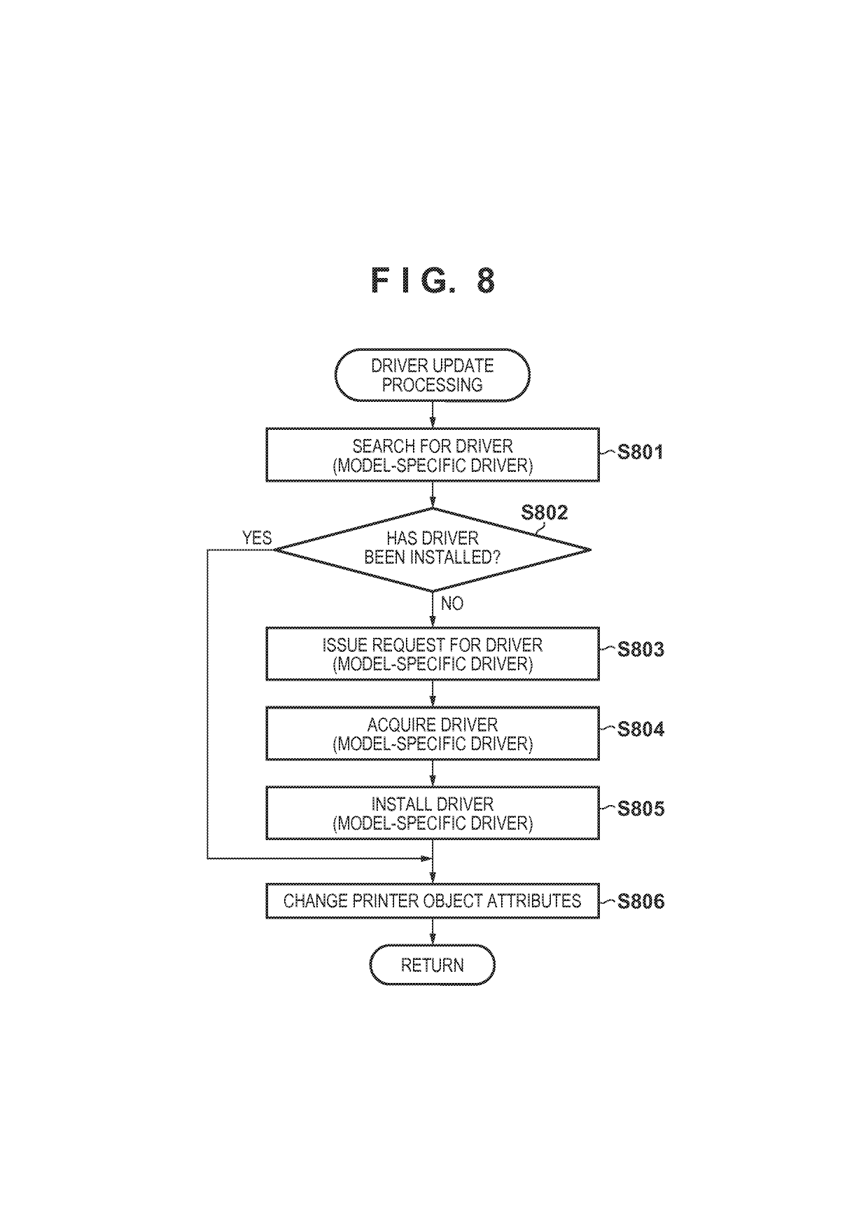

The details of driver update processing of the print system 312 in the client PC 103 will be described next with reference to the flowchart shown in FIG. 8.

In step S801, the print system 312 searches for the printer driver indicated by the designated driver identifier (that is, the model-specific printer driver 314) and confirms whether the driver has already been registered (installed).

If the print system 312 determines in step S802 that the model-specific printer driver 314 has been registered (YES in step S802), the process advances to step S806. If the print system 312 determines that the model-specific printer driver 314 has not been registered (NO in step S802), the process advances to step S803, in which the print system 312 requests the distribution server 104 for the driver set of the model-specific printer driver 314. In step S804, the print system 312 acquires the driver set of the model-specific printer driver 314 in response to the request from the distribution server 104. In step S805, the print system 312 installs the received driver set.

In step S806, the print system 312 sets the identifier of the installed model-specific printer driver 314 and a driver version to a driver identifier 503 of a printer object as an update target and the driver version 504.

As described above, the basic printer driver 302 is installed in the print server 102 in advance, and a printer driver is installed in the client PC 103 by Point and Print. As a consequence, the printer driver is automatically updated to the model-specific printer driver 314 by using the driver information service 303. Even if, therefore, the model of the printer 101 as a shared printer is changed, it is possible to install the model-specific printer driver 314 corresponding to the changed model in the client PC 103. In this case, the print server 102 need not make any change, for example, re-installation of the basic printer driver 302 for which shared settings have been made.

### Second Embodiment

The first embodiment has exemplified the case in which immediately after the basic printer driver 313 is installed in the client PC 103, the driver is updated to the appropriate model-specific printer driver 314. If, however, the model of the printer 101 as a shared printer is changed, since the model-specific printer driver 314 previously installed in the client PC 103 does not correspond to the printer 101 after the model change, the printer may not properly print. Some printer 101 may hang up.

For this reason, the second embodiment is configured to execute the driver initialization processing shown in FIG. 7 in initialization processing at the time of startup of a model-specific printer driver 314. With this configuration, when the model of a printer 101 as a shared printer is changed, the previously installed model-specific printer driver 314 is automatically updated to the model-specific printer driver 314 corresponding to the currently connected printer 101.

### Third Embodiment

In the first and second embodiments, providing the driver information service 303 for the print server 102 implements updating to the model-specific printer driver 314. However, since the driver information service 303 communicates with a printer driver using a unique protocol, the driver information service 303 is generated for each printer driver or its maker. As a result, a plurality of driver information services 303 simultaneously operate on the same print server 102, and hence the print server 102 consumes a large amount of memory, resulting in an increase in processing load on the CPU.

In the third embodiment, therefore, for example, a print system 301 provided by an OS incorporates an inquiry I/F, which the driver information service 303 has, for the model-specific printer driver of a printer 101, thereby providing it as a standard function.

Another module arrangement example of a network system according to the third embodiment will be described with reference to the block diagram shown in FIG. 11. It is possible to cope with a plurality of basic printer drivers 302 even by using a print server 102 with less memory.

In addition, since there is no need to install a driver information service 303 in the print server 102 and change the firewall settings concerning communication with the driver information service 303, it is possible to decrease the management cost of the system manager.

### Fourth Embodiment

The first embodiment allows the user to perform control for updating to the model-specific printer driver 314 at the time of installation by Point and Print. The second embodiment allows the user to perform control for updating to a new model-specific printer driver at the time of startup of the model-specific printer driver 314.

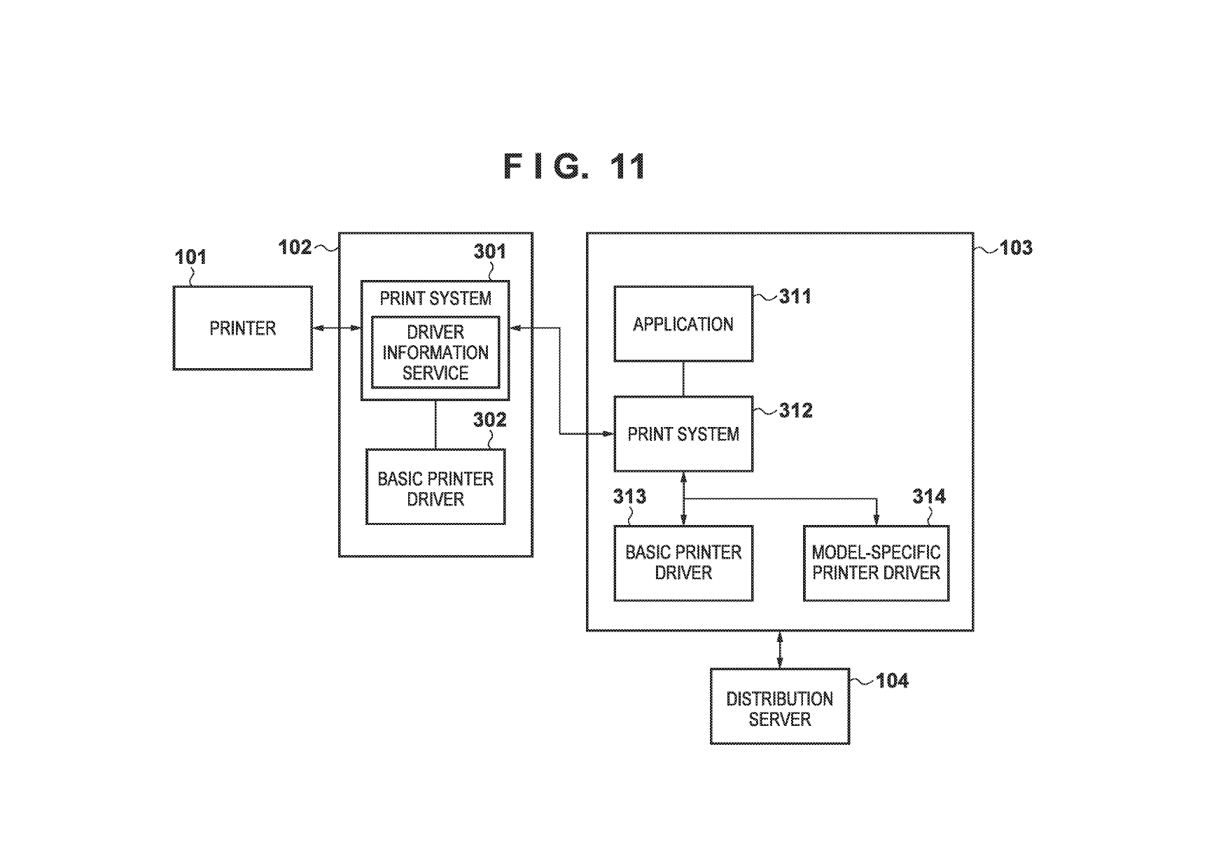

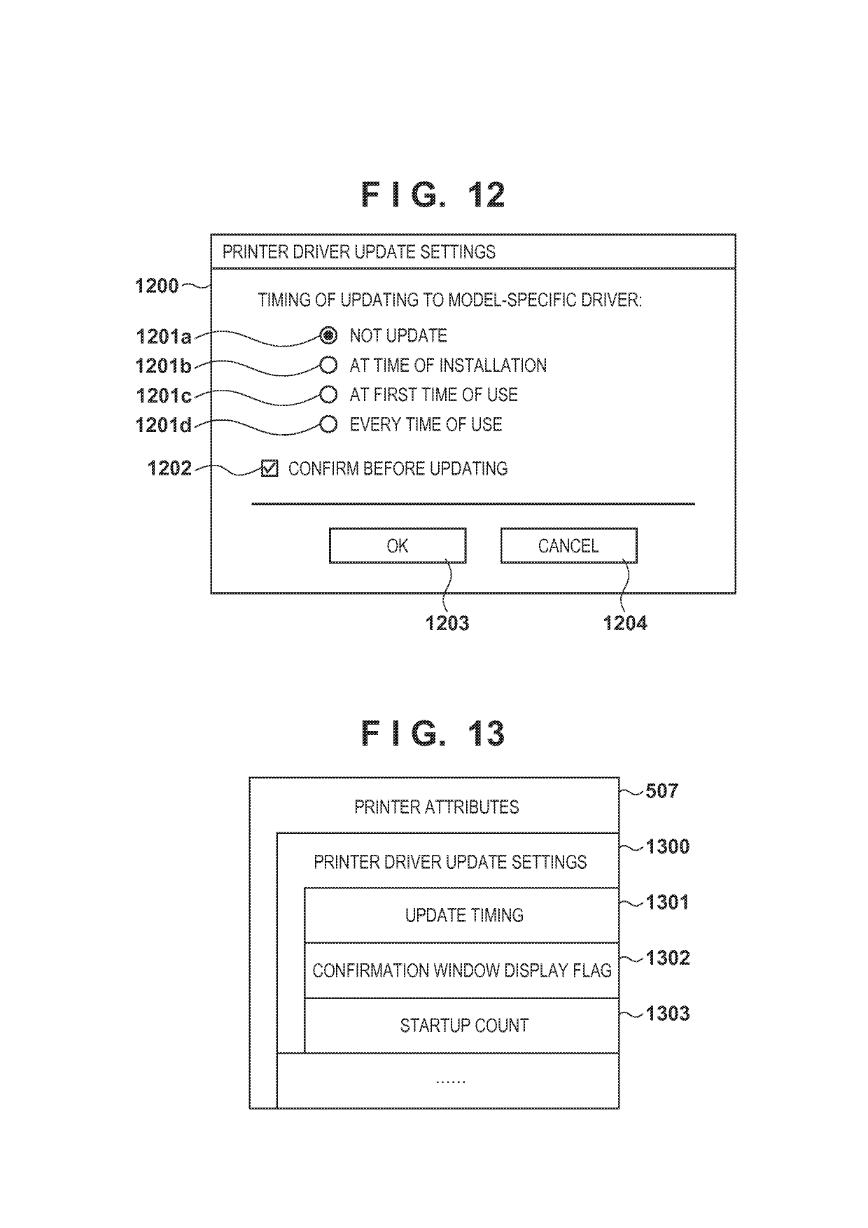

The fourth embodiment allows a general user or system manager to control the update timing. An example of a user interface window for making printer driver update settings for a basic printer driver 302 will be described first with reference to FIG. 12. A printer driver update setting window 1200 is invoked from a setting window for printer attributes 507 of printer object attributes 500.

The user selects the update timing shown in FIG. 12 from one of a plurality of radio buttons for designating the timings of updating to a model-specific printer driver. If the user selects “not update” 1201a, the system does not update the printer driver to a model-specific printer driver. The default which the basic printer driver 302 itself has is “not update” 1201a, otherwise it is not possible to install the basic printer driver 302 in a print server 102.

When the user selects “at time of installation” 1201b, a basic printer driver 313 is updated to a model-specific printer driver only when the basic printer driver 313 is installed from the print server 102 into a client PC 103 by Point and Print. When the user selects “at first time of use” 1201c, the basic printer driver 313 is updated to a model-specific printer driver only when the basic printer driver 313 is used for the first time after it is installed from the print server 102 in the client PC 103 by Point and Print. If the user selects “every time of use” 1201d, the basic printer driver 313 is updated to a model-specific printer driver every time the basic printer driver 313 installed by Point and Print is used. It is possible to provide choices of other update timings.

“Confirm before updating” 1202 is a checkbox for designating whether to display a window for confirming whether to perform updating to a model-specific printer driver. When the user checks the “confirm before updating” 1202, the user can perform control for updating to a model-specific printer driver. If the user does not check the “confirm before updating” 1202, the printer driver is automatically updated at either of the timings 1201b to 1201c.

When the user selects “not update” 1201a at the update timing, “confirm before updating” 1202 is ignored. When the user presses an “OK” button 1203, the system closes the printer driver update setting window 1200. The system then stores the set values of the printer driver update setting window 1200 as part of the printer attributes 507 of the printer object attributes 500 of the printer object as a setting target.

An example of the data structure of printer driver update settings 1300 included in the printer attributes 507 will be described next with reference to FIG. 13. The printer driver update settings 1300 include an update timing 1301, a confirmation window display flag 1302, and a startup count 1303. The update timing 1301 serves to store the set value of an update timing. The confirmation window display flag 1302 serves to store “1” if “confirm before updating” 1202 is checked, and to store “0” if “confirm before updating” 1202 is not checked. The startup count 1303 is a value indicating the startup count of the basic printer driver 313, which is not set on the printer driver update setting window 1200. This value will be described in detail later.

Referring back to FIG. 12, when the user presses a “cancel” button 1204, the system closes the printer driver update setting window 1200 without performing anything. The first embodiment has exemplified the case in which the user selects “at time of installation” 1201b as an update timing, and checks “confirm before updating” 1202. When the user installs a printer driver by Point and Print, the printer object attributes 500 of the print server 102 are distributed and set to the printer object attributes 500 of the client PC 103.

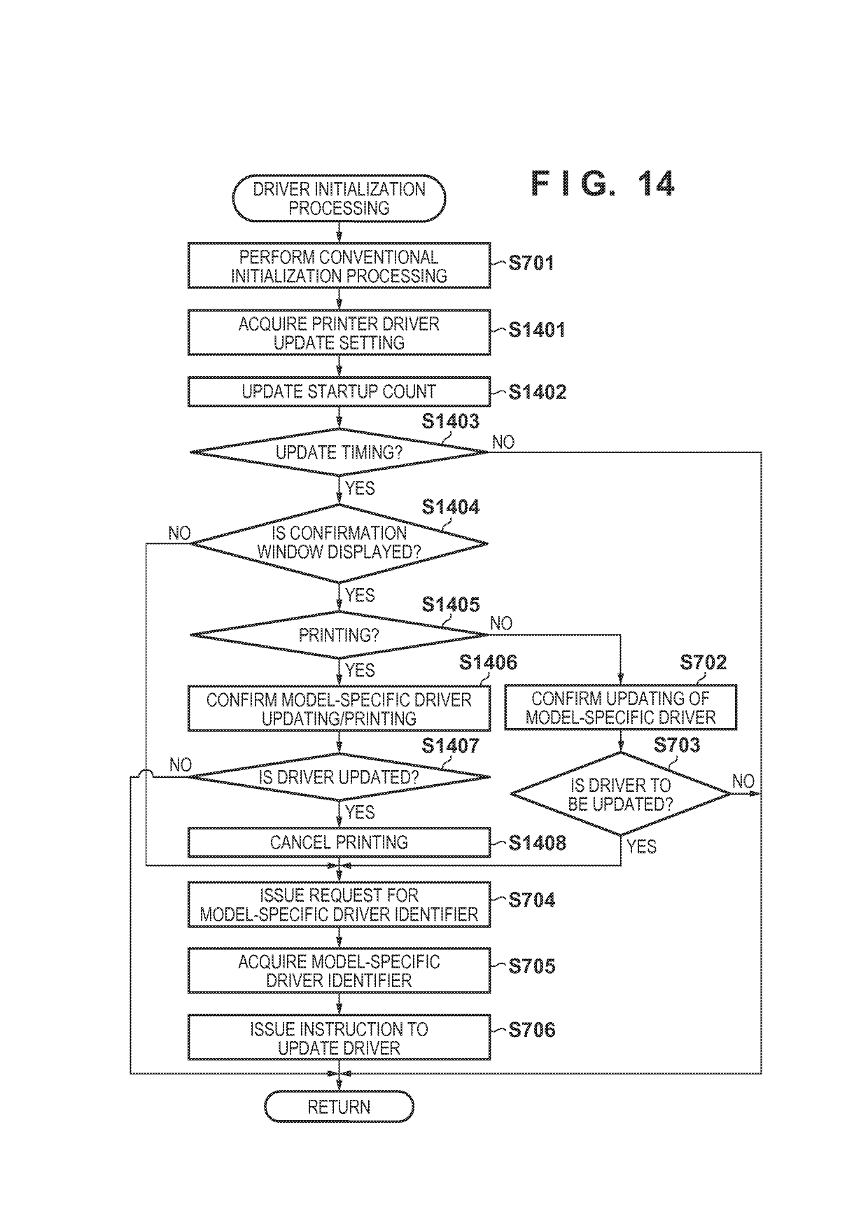

The details of initialization processing of the basic printer driver 313 in the client PC 103 according to the fourth embodiment will be described next with reference to the flowchart shown in FIG. 14. The same reference numerals as in FIG. 7 denote the same processes in the first embodiment, and a description of them will be omitted.

Upon performing conventional initialization processing in step S701, the basic printer driver 313 acquires the printer driver update settings 1300 of the printer object in step S1401. In step S1402, the basic printer driver 313 updates the startup count 1303 of the printer driver update settings 1300. Note that the initial value of the startup count 1303 is “0”. If the startup count 1303 is “0”, the value is changed to “1”. If the startup count 1303 is “1”, the value is changed to “2”. If the startup count 1303 is “2”, the value is kept unchanged.

That is, “0” of the startup count 1303 acquired in step S1401 indicates that the current time is the time of installation, “1” of the startup count 1303 indicates that the driver has been used for the first time, and “2” of the startup count 1303 indicates that the driver has been used twice or more.

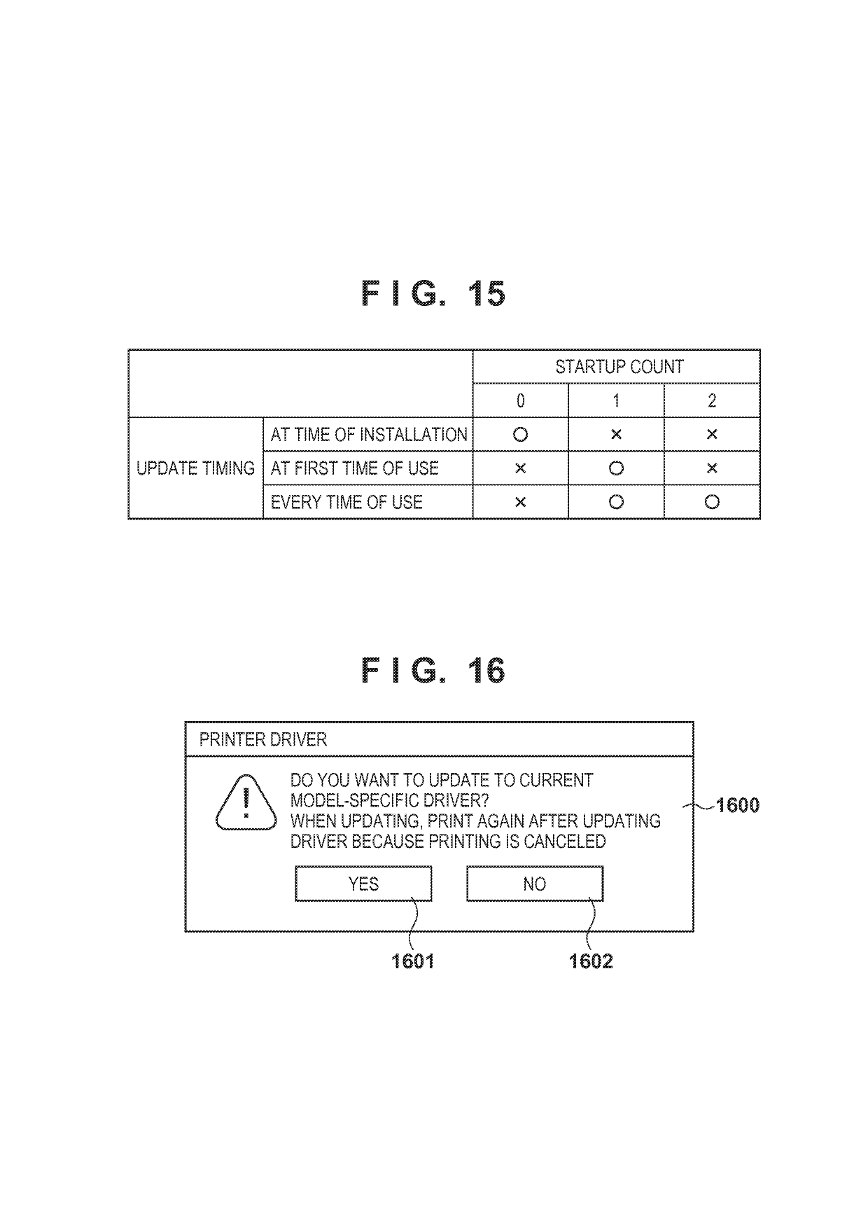

In step S1403, the basic printer driver 313 determines, from the update timing 1301 and startup count 1303 of the printer driver update settings 1300 acquired in step S1401, whether the current time is an update timing. In the case of “0” in FIG. 15, the basic printer driver 313 determines that the current time is an update timing.

That is, when the update timing 1301 is “at time of installation” and the startup count 1303 is “0”, the basic printer driver 313 determines that the current time is an update timing. Alternatively, when the update timing 1301 is “at first time of use” and the startup count 1303 is “1”, the basic printer driver 313 determines that the current time is an update timing. Alternatively, when the update timing 1301 is “every time of use” and the startup count 1303 is “1” or more, the basic printer driver 313 determines that the current time is an update timing.

Upon determining in step S1403 that the current time is not an update timing (NO in step S1403), the basic printer driver 313 terminates this processing. If the basic printer driver 313 determines that the current time is an update timing (YES in step S1403), the process advances to step S1404 to determine whether to display a model-specific printer driver update confirmation window. The basic printer driver 313 determines this by a method of determining whether the confirmation window display flag 1302 is “1”.

If the basic printer driver 313 determines in step S1404 that it does not display the model-specific printer driver update confirmation window (NO in step S1404), the process advances to step S704. If the basic printer driver 313 determines that it displays the model-specific printer driver update confirmation window (YES in step S1404), the process advances to step S1405 to determine whether the user is currently performing printing operation using the application 311. The basic printer driver 313 performs this determination by the following method. If, for example, the authority of the process that is evoking the basic printer driver 302 is a system authority, the basic printer driver 313 determines that printing operation is performed from the application 311.

If the basic printer driver 313 determines in step S1405 that printing operation is not performed from the application 311 (NO in step S1405), the process advances to step S702 to display a window like that shown in FIG. 10 and make the user select updating to the model-specific printer driver 314.

If the basic printer driver 313 determines in step S1405 that printing operation is performed from the application 311 (YES in step S1405), the process advances to step S1406 to display a model-specific printer driver updating/printing confirmation window 1600 shown in FIG. 16. When updating the printer driver to a model-specific printer driver during printing from the application 311, it is necessary to cancel the current printing operation. The system therefore prompts the user to re-print after updating of the driver.

In this case, if the user wants to update the basic printer driver 313 to the model-specific printer driver 314, he/she presses a “YES” button 1601. If the user wants to keep the basic printer driver 313 unchanged, he/she presses a “NO” button 1602. When the user presses the “YES” button 1601 or the “NO” button 1602, the system closes the model-specific printer driver updating/printing confirmation window 1600.

If the basic printer driver 313 determines in step S1407 that the user has pressed the “NO” button 1602 (NO in step S1407), the driver terminates this processing. If the basic printer driver 313 determines that the user has pressed the “YES” button 1601 (YES in step S1407), the process advances to step S1408 to cancel the current printing operation. The process then advances to step S704.

The above processing allows a general user or system manager to control the timing of updating the basic printer driver 313 installed in the client PC 103 by Point and Print to the model-specific printer driver 314. In addition, the system manager can perform control to make a general user select a specific update timing. The general user can select on a confirmation window whether to update the printer driver.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2011-227438 filed Oct. 14, 2011 and 2012-156926 filed Jul. 12, 2012, which are hereby incorporated by reference herein in their entirety.

1. A network system in which a server apparatus is connected to a client apparatus via a network, wherein
the server apparatus includes
a transmission unit configured to transmit identification information used to install a model-specific printer driver corresponding to a printer having undergone shared setting in accordance with a request from the client apparatus, and
the client apparatus includes
a request unit configured to issue a request for the identification information to the server apparatus to update a basic driver which corresponds to a printer having undergone shared setting in the server apparatus and has been installed by using Point and Print, and
a control unit configured to control installation of the model-specific printer driver by using the identification information transmitted in accordance with the request.

2. The system according to claim 1, wherein when a model-specific printer driver corresponding to a printer having undergone shared setting in the server apparatus is not installed in the client apparatus, said request unit issues a request for the identification information to the server apparatus to perform updating to the model-specific printer driver.

3. The system according to claim 1, wherein a timing when said request unit issues a request is one of timings when a printer driver is installed, when the printer driver is used for the first time, and every time the printer driver is used.

4. The system according to claim 1, wherein the client apparatus further includes a setting unit configured to set not to make said request unit issue any request.

5. The system according to claim 1, wherein the server apparatus provides said transmission unit as a function of an operating system.

6. The system according to claim 1, wherein the model-specific printer driver is distributed from a distribution system in the network.

7. The system according to claim 1, wherein a basic driver installed in the client apparatus using the Point and Print is a printer driver managed as an in-box driver by an operating system of the client apparatus.

8. A method in a network system in which a server apparatus is connected to a client apparatus via a network, comprising:
in the server apparatus,
transmitting identification information used to install a model-specific printer driver corresponding to a printer having undergone shared setting in accordance with a request from the client apparatus, and
in the client apparatus,
issuing a request for the identification information to the server apparatus to update a basic driver which corresponds to a printer having undergone shared setting in the server apparatus and has been installed by using Point and Print, and
controlling installation of the model-specific printer driver by using the identification information transmitted in accordance with the request.

9. A client apparatus connected to a server apparatus via a network, comprising:
a request unit configured to issue a request for identification information used to install a model-specific printer driver corresponding to a printer which has undergone shared setting in the server apparatus and is installed by using Point and Print to update a basic driver corresponding to the printer having undergone shared setting; and
a control unit configured to perform control to install the model-specific printer driver by using identification information transmitted in accordance with the request.

10. The apparatus according to claim 9, wherein when a model-specific printer driver corresponding to a printer having undergone shared setting is not installed in the client apparatus, said request unit issues a request for the identification information to the server apparatus to perform updating to the model-specific printer driver.

11. The apparatus according to claim 9, wherein a timing when said request unit issues a request is one of timings when a printer driver is installed, when the printer driver is used for the first time, and every time the printer driver is used.

12. The apparatus according to claim 9, further comprising a setting unit configured to set not to make said request unit issue any request.

13. The apparatus according to claim 9, wherein the model-specific printer driver is distributed from a distribution system in the network.

14. The apparatus according to claim 9, wherein a basic driver installed using the Point and Print is a printer driver managed as an in-box driver by an operating system of the client apparatus.

15. A method in a client apparatus connected to a server apparatus via a network, comprising:
issuing a request for identification information used to install a model-specific printer driver corresponding to a printer which has undergone shared setting in the server apparatus and is installed by using Point and Print to update a basic driver corresponding to the printer having shared setting; and
performing control to install the model-specific printer driver by using identification information transmitted in accordance with the request.

16. A program for causing a computer to function as a unit defined in claim 9.
